(19) United States
(12) Patent Application Publication
(10) Pub. No.: US 2017/0091622 A1
(43) Pub. Date: Mar. 30, 2017

(54) SYSTEMS AND METHODS FOR GENERATING FORECASTING MODELS

(71) Applicant: Facebook, Inc., Menlo Park, CA (US)

(72) Inventor: Sean Jude Taylor, San Francisco, CA (US)

(21) Appl. No.: 14/863,802

(22) Filed: Sep. 24, 2015

(51) Int. Cl. G06N 5/02

(52) U.S. Cl. CPC G06N 5/022

(57) ABSTRACT

Systems, methods, and non-transitory computer-readable media can receive a time series data set. At least one simulated forecast time period for the time series data set can be determined. One or more parameters for generating one or more forecasting models for the time series data set can be determined. The one or more forecasting models can be generated based at least in part on the one or more parameters and on the at least one simulated forecast time period. The one or more forecasting models can be evaluated to determine an optimal forecasting model for the time series data set.

### FIELD OF THE INVENTION

The present technology relates to the field of generating forecasting models. More particularly, the present technology relates to techniques for automatically generating forecasting models for various time series.

### BACKGROUND

People often utilize computing devices (or systems) for a wide variety of purposes. Users can use their computing devices to, for example, interact with one another, create content, share information, and access information. In some instances, a user can operate a computing device to build statistical models for forecasting or predicting future outcomes or values.

Under conventional approaches, a user can operate the computing device to build forecasting models for a time series data set, for example. A time series generally includes a sequence of data points consisting of successive measurements that are made over some period of time, such as the price of a stock that is measured daily over a year. Such forecasting models can be used to estimate, or predict, future values based on the previously observed values that are included in the time series data set.

A variety of methods can be applied to generate the forecasting model including, for example, moving average, weighted moving average, Kalman filtering, autoregressive integrated moving average (ARIMA), to name some examples. The process for generating a forecasting model can vary depending on the time series data set on which the model is being built. Given that a number of different methods can be applied to generate the model, and that each method may have various configuration options for optimizing the model, the process for generating and selecting an optimal model can be difficult and time intensive.

### SUMMARY

Various embodiments of the present disclosure can include systems, methods, and non-transitory computer readable media configured to receive a time series data set. At least one simulated forecast time period for the time series data set can be determined. One or more parameters for generating one or more forecasting models for the time series data set can be determined. The one or more forecasting models can be generated based at least in part on the one or more parameters and on the at least one simulated forecast time period. The one or more forecasting models can be evaluated to determine an optimal forecasting model for the time series data set.

In an embodiment, a design matrix for the time series data set can be generated. The design matrix can store information describing at least a set of respective observations for each unit identified in the time series data set.

In an embodiment, determining the at least one simulated forecast date can include allocating a first portion of observations in the time series data set to a first set of observations, wherein observations in the first set are used to forecast simulated values and allocating a second portion of observations in the time series data set to a second set of observations, wherein observations in the second set are used to measure a respective accuracies of the simulated values.

In an embodiment, determining the one or more parameters includes determining a space of kernel parameters and determining a space of regularization parameters.

In an embodiment, the one or more generated forecasting models can each correspond to the at least one simulated forecast time period and each combination of the one or more parameters.

In an embodiment, evaluating the one or more forecasting models includes determining at least one characteristic of the time series data set, determining at least one different time series data set that corresponds to the at least one characteristic, and determining a respective forecasting accuracy of each model in the one or more forecasting models with respect to the time series data set and the at least one different time series data set.

In an embodiment, evaluating the one or more forecasting models includes determining a first portion of observations in the time series data set, determining a second portion of observations in the time series data set, wherein observations included in the second portion are different from the observations included in the first portion, generating, using a model in the one or more forecasting models, at least one forecasted value using observations in the first portion, wherein the forecasted value corresponds to an observation included in the second portion of observations, and determining a forecasting accuracy for the model based at least in part on a comparison of the at least one forecasted value with a known value corresponding to the observation included in the second portion of observations.

In an embodiment, evaluating the one or more forecasting models includes generating an error model based at least in part on the evaluation of the one or more forecasting models.

In an embodiment, generating the error model includes measuring respective empirical errors for one or more forecasted values made using at least one forecasting model and training the error model based at least in part on the one or more forecasted values and the respective empirical errors.

In an embodiment, at least one forecasted value can be generated using a model in the one or more forecasting models and a confidence interval for the at least one forecasted value can be determined using the error model.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example model generator module, according to an embodiment of the present disclosure.

FIG. 2 illustrates an example forecasting module configured to generate forecasting models for a time series data set, according to an embodiment of the present disclosure.

FIG. 3 illustrates an example diagram illustrating a process for generating forecasting models, according to an embodiment of the present disclosure.

FIG. 4 illustrates an example illustration of a design matrix, according to various embodiments of the present disclosure.

FIG. 5 illustrates an example method that depicts generating a forecasting model for a time series, according to an embodiment of the present disclosure.

FIG. 6 illustrates an example method for generating an error model, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Automatically Generating Forecasting Models

As mentioned, a user can operate a computing device to build statistical models for forecasting, or predicting, future values using, for example, a time series data set. Such forecasting models can be used to estimate, or predict, future values based on the observed values that are included in the time series data set. Under conventional approaches, the process of building a forecasting model can vary depending on the time series data set for which the model is being generated. As mentioned, a variety of methods can be used to build the model. In some instances, the accuracy of results obtained from a model generated using one method can vary from the results that were obtained from a model generated using a different method. Further, each method may be configurable in a number of different ways. Such complexities can make the process of generating and selecting an optimal model for a given time series data set more difficult and time intensive.

An improved approach overcomes the foregoing and other disadvantages associated with conventional approaches. In general, a computing system (or device) can be configured to automatically generate and select forecasting models that provide optimal forecasts for a given time series. For example, in various embodiments, a time series data set can be provided as an input to the computing device. The computing device can perform various operations on the data set, such as feature extraction, to generate a design matrix that organizes the data set. A space of models can be evaluated with respect to the time series data set to determine the model, and parameters, that optimally, or best, forecast future values for the time series. The evaluation of models can include, for example, cross-sectional validation of the time series data set with respect to other similar time series data sets and performing simulated forecasts using a portion of the time series data set to test the accuracy of the different models being evaluated. In some instances, once an optimal model has been determined, the model can be implemented for purposes of forecasting future values in the data set. By utilizing such an approach, users can easily generate forecasting models that best fit a given time series data set without having to invest time and effort into manually building and optimizing such models.

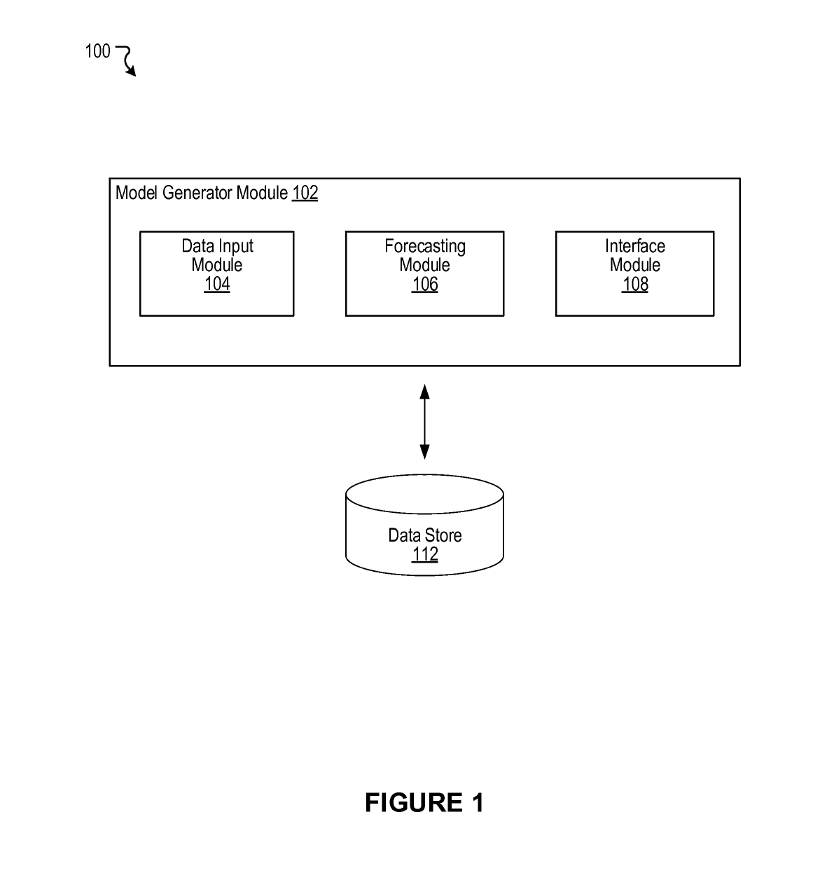

FIG. 1 illustrates an example system 100 including an example model generator module 102 configured to generate forecasting models for a time series data set, according to an embodiment of the present disclosure. As shown in the example of FIG. 1, the model generator module 102 can include a data input module 104, a forecasting module 106, and an interface module 108. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

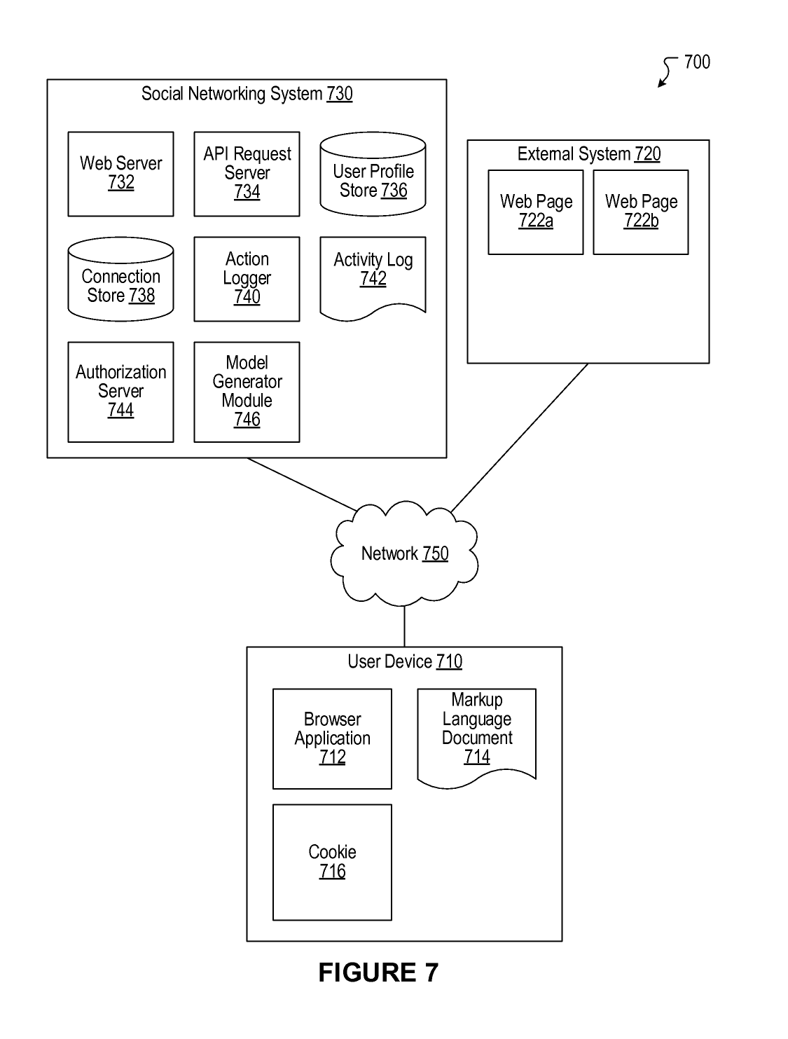

In some embodiments, the model generator module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the model generator module 102 can be implemented, in part or in whole, as software running on one or more computing devices or systems, such as on a user- or client computing device. For example, the model generator module 102, or at least a portion thereof, can be implemented as or within an application (e.g., app), a program, or an applet, etc., running on a user computing device or a client computing system, such as the user device 710 of FIG. 7. In another example, the model generator module 102, or at least a portion thereof, can be implemented using one or more computing devices or systems that include one or more servers, such as network servers or cloud servers. In some instances, the model generator module 102 can, in part or in whole, be implemented within or configured to operate in conjunction with a social networking system (or service), such as the social networking system 730 of FIG. 7. It should be understood that there can be many variations or other possibilities.

In some embodiments, the data input module 104 can be configured to receive time series data sets. The data sets can be provided in any structured or non-structured format. Typically, each data set can include a series of observations over a period of time. For each observation, the data set can include one or more respective units and any number of features. A unit can refer to any discrete entity, such as a country, user identifier, webpage identifier, webpage type, etc. A feature can be, for example, any individual measurable property of a phenomenon being observed. Further, for each unit, the data set can include a respective value. For example, a time series data set can correspond to daily closing prices for a particular stock over some period of time. In this example, each observation corresponds to a day that falls within the period of time, the unit is the stock, and the value is the closing price of the stock for the day.

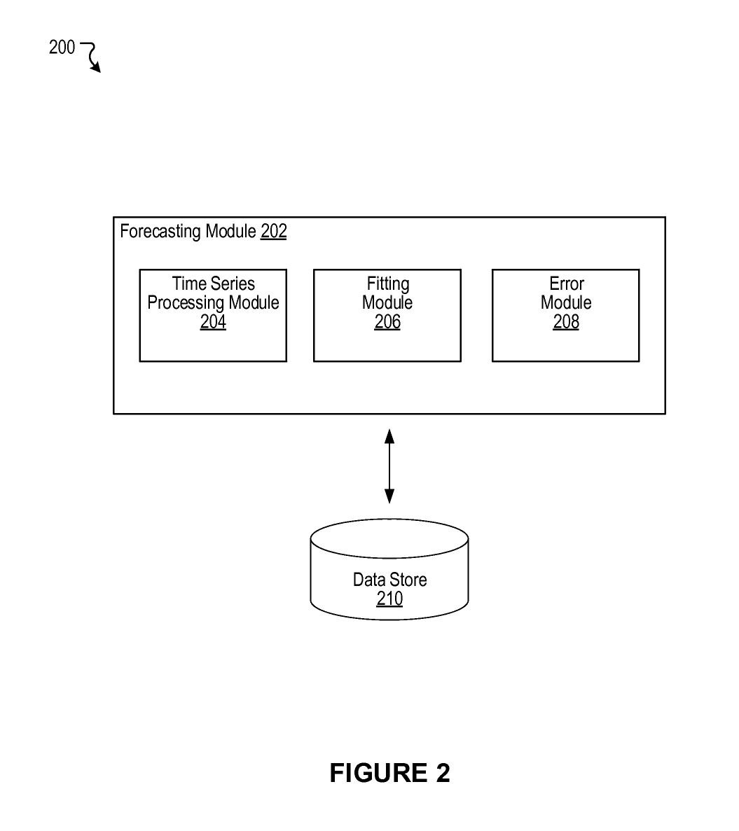

The forecasting module 106 can be configured to process a time series data set using various techniques and approaches to determine one or more forecasting models that best forecast future values for that time series. More details regarding the forecasting module 106 will be provided below in reference to FIG. 2.

The interface module 108 can be configured to provide an interface for requesting and accessing forecasting models for any given time series data set. The interface can be any type of interface including, for example, a web-based interface, a command line interface, an application programming interface (API), to name some examples. Users can interact with the model generator module 102 through the interface, for example, to provide time series data sets, access and/or modify forecasting models generated for any time series data sets, access visual representations of the time series data sets and forecasts, as well as to request, or generate, forecasts for a time series data set using a forecasting model generated by the forecasting module 106. In various embodiments, a forecasting model generated for a time series can be downloaded through the interface module 108, for example, in the form of a file. The downloaded forecasting model can then be implemented on a computing system and the computing system can utilize the forecasting model to perform the various operations described in this disclosure. For example, the computing system on which the forecasting model is implemented can be used to make forecasts using the forecasting model.

FIG. 2 illustrates an example forecasting module 202 configured to generate forecasting models for a time series data set, according to an embodiment of the present disclosure. In some embodiments, the forecasting module 106 of FIG. 1 can be implemented with the forecasting module 202. As shown in the example of FIG. 2, the forecasting module 202 can include a time series processing module 204, a fitting module 206, and an error module 208.

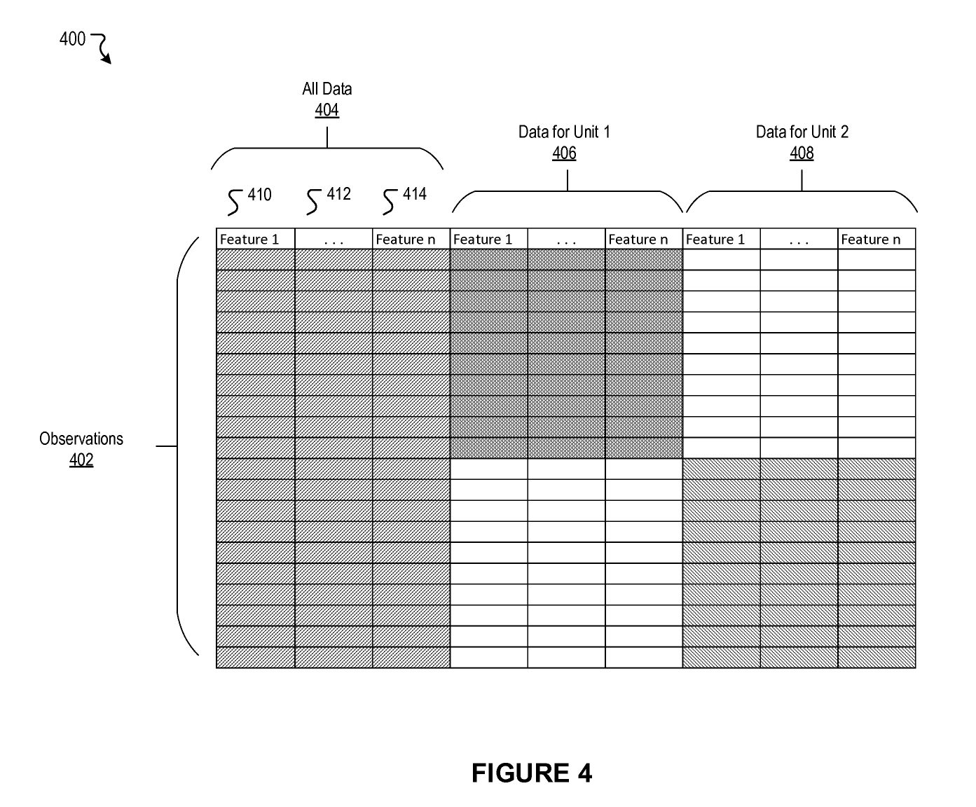

The time series processing module 204 can be configured to process any time series data sets that are received, for example, by the data input module 104 of FIG. 1, for which forecasting models are to be generated. In various embodiments, the time series processing module 204 can extract any features that are present in a time series data set using generally known feature extraction techniques. In some embodiments, the time series processing module 204 can generate a design matrix corresponding to the time series data set. The design matrix can be a data structure, such as a two-dimensional or three-dimensional matrix, that is generated for storing information about the time series data set. An illustration of an example design matrix is provided in FIG. 4.

The fitting module 206 can be configured to perform techniques for evaluating the time series data set with respect to various classes, or types, of models. In some embodiments, the fitting module 206 can evaluate an extensible space of models for the time series data set. Some examples of models that can be evaluated include flat line, growth curves, periodicity (e.g., weekly, monthly, yearly, etc.), splines (e.g., cyclic splines), random walks, autoregressive, integrated, moving average, autoregressive moving average (ARMA), and autoregressive integrated moving average (ARIMA). Any combination of models can be evaluated depending on the class, or characteristics, of the time series. In some instances, the space of models being evaluated can be restricted by specifying attributes of the time series. For example, a user can specify that, for a given time series, that the time series does not correspond to any growth curves or weekly periodicity. In this example, when evaluating the space of models, the fitting module 206 can exclude any growth curve or weekly periodicity analysis for the time series.

In some embodiments, the fitting module 206 can further evaluate models based on various parameters, such as kernel parameters, regularization parameters, or both. A kernel can be implemented, for example, to adjust the weighting of observations in a time series. For example, a kernel can be utilized to discount early observations in a time series while giving greater weight to observations that were measured more recently. Such techniques can be used, for example, to aid in the selection of forecasting models that best fit the time series on the recent observations (e.g., days 30 to 60) while giving less weight to how the model fits the time series with respect to the earlier observations (e.g., days 1 to 29). Kernel parameters can be predefined or specified by users. In some embodiments, the fitting module 206 can evaluate models based on a space of kernel parameters (e.g., 0 to 1) with respect to the different models being tested for a given time series to determine the optimal forecasting model for the time series. In various embodiments, regularization parameters can also be implemented to aid in the evaluation of models generated by the fitting module 206. For instance, regularization parameters can be used to penalize a model for over-fitting a time series or for smoothing. Like kernel parameters, regularization parameters may be predefined or specified by users. Further, the fitting module 206 can evaluate modules based on a space of regularization parameters (e.g., 0 to 1) with respect to the different models being tested for a given time series to determine the optimal forecasting model for the time series. In various embodiments, both kernel parameters and regularization parameters can be utilized to evaluate models. In such embodiments, a model can be evaluated with respect to each combination of kernel parameters and regularization parameters.

In some embodiments, the fitting module 206 can measure the forecasting accuracy of each model being tested by cross-validating the model against one or more similar time series data sets that share characteristics with the time series data set. For example, a model for a time series that corresponds to daily closing values for a stock over a period of time can be cross-validated using time series data sets that correspond to daily closing values for other stocks over the same period of time. Such cross-validation can provide additional insight when testing models and can be used to refine the models so that the models perform well across the different time series.

In some embodiments, the fitting module 206 can also measure the forecasting accuracy of each model by using the model to forecast known values for one or more dates, or time periods, and comparing the forecasted values with the respective actual values for those dates, or time periods. For example, assuming a time series has 90 observations, the fitting module 206 can use the observations 61-90 as simulated forecast dates. While ignoring the actual values for the observations 61-90, the fitting module 206 can then use observations 1-60 to forecast values for observations 61-90. Since the actual values for the observations 61-90 are known, the fitting module 206 can compare the forecasted values for observations 61-90 with the respective actual values for the observations 61-90 to determine the forecasting accuracy of the model. The respective accuracies of the forecasting models, along with other factors, can be evaluated to select one or more forecasting models that are optimal for the time series data set. In various embodiments, an objective function can be utilized for purposes of determining which model is optimal for a given time series.

The fitting module 206 can determine a final model for the time series data set, for example, by selecting the model that produced the best forecasts for the time series data set. The respective errors that correspond to forecasts made using a model can be used to gauge the accuracy of the model. The model that produces forecasts with the lowest error rate can be selected as the final model. In various embodiments, the fitting module 206 can improve the rate at which models are evaluated by using generally known parallelization approaches.

The error module 208 can measure respective empirical errors that result from the models being evaluated by the fitting module 206. In various embodiments, these empirical errors can be used to determine respective confidence intervals for each model being evaluated. For example, for each model, the error module 208 can determine a respective empirical error for a given vintage (e.g., simulated forecast), unit, and date. The error module 208 can use the forecasted values and the empirical errors to train an error model by applying various machine learning techniques (e.g., gradient boosting).

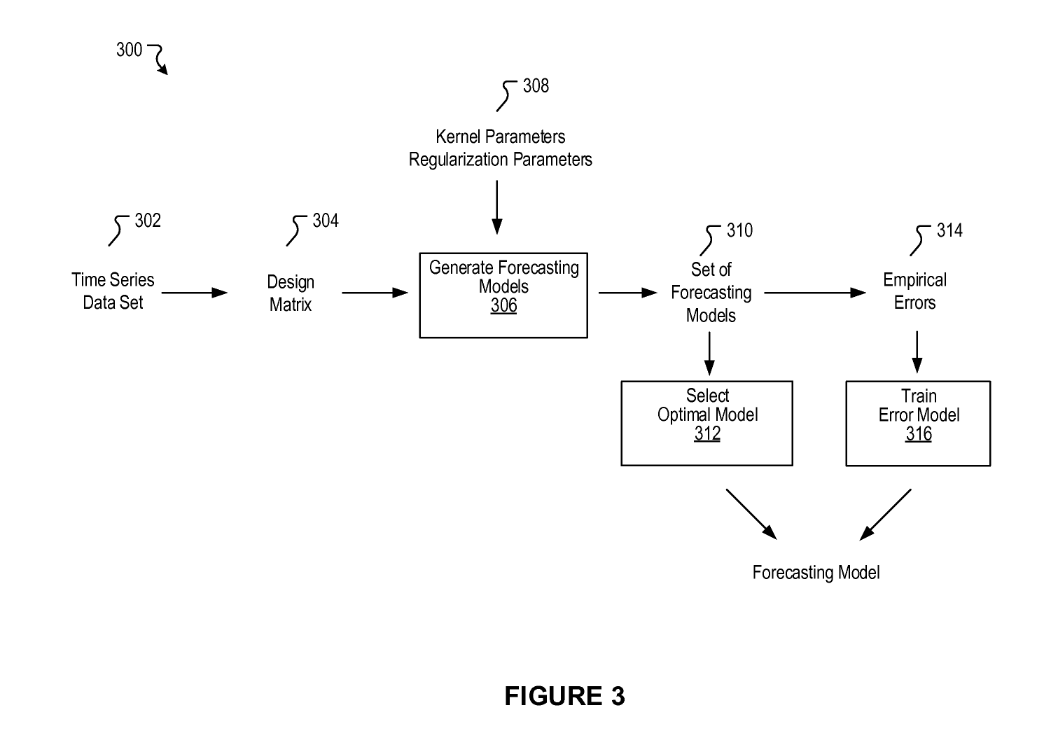

FIG. 3 illustrates an example diagram 300 illustrating a process for generating forecasting models, according to an embodiment of the present disclosure. As shown in the example diagram 300, an optimal forecasting model for a time series data set 302 can be determined by generating 304 a design matrix. In various embodiments, the design matrix may have a respective column entry for each unit corresponding to the data set and a respective row entry for each observation in the data set. Feature extraction can be performed when generating the design matrix to extract any sets of features that are present in the time series data set. A feature can be, for example, any individual measurable property of a phenomenon being observed. The respective column for each unit in the design matrix can include respective sub-columns that each correspond to a feature, or set of features, that was extracted from the data set 302. An illustration of an example design matrix is provided in FIG. 4.

Using the design matrix, a set of forecasting models can be generated 306. In various embodiments, the set of forecasting models can be generated based on at least a space of parameters 308 (e.g., kernel parameters and regularization parameters) and on a set of simulated forecast dates. The space of parameters 308 to be evaluated can be predefined or specified by a user. For example, a user may specify a space of kernel parameters [0,1] and a space of regularization parameters [0,1] to evaluate.

The simulated forecast dates can be determined using portions of the design matrix. For example, when simulating a forecast for days 60-90, the portion of the design matrix that includes observations for days 1-59 can be used. In another example, when simulating a forecast for days 91-120, the portion of the design matrix that includes observations for days 1-90 can be used. The set of models 310 to be evaluated includes a separate model for each simulated forecast date and for each combination in the space of parameters 308. Thus, for example, if the space of parameters 308 being tested includes 100 parameters (e.g., 10 kernel parameters and 10 regularization parameters) and if the number of simulated forecast dates is 10, then a total of 1,000 models will be evaluated.

Models in the set of forecasting models 310 can be evaluated in various ways, such as measuring the forecasting accuracy by cross-validating the respective model using similar time series and also measuring the forecasting accuracy of the respective models using simulated forecast dates or time periods, as described above. A model having an optimal, or best, combination of parameters can be selected 312. While evaluating the set of forecasting models 310, empirical errors 314 corresponding to each model can be determined. An error model can be trained 316 based on the empirical errors 314. The trained error model can be utilized to determine confidence intervals for forecasts made using a model.

FIG. 4 illustrates an example illustration of a design matrix 400, according to various embodiments of the present disclosure. As illustrated in the example of FIG. 4, the design matrix 400 includes as many rows 402 as the number of observations that were included in the time series data set. The design matrix 400 includes a column 404 that includes data that corresponds to the entire time series data set, such as every observation included in the time series data set. The design matrix 400 also includes respective columns 406, 408 for each unit identified from the time series data set. For example, in a time series data set that includes various observations made in the United States and in Canada, the design matrix 400 can include one column 406 for observations made in the United States and another column 408 for observations made in Canada. Each column 404, 406, 408 in the design matrix 400 can include respective sub-columns 410, 412, 414 that each correspond to a feature, or set of features, that was extracted from the time series data set. The sub-columns 410, 412, 414 represent the space of models that are being evaluated for the time series. Since the size of the design matrix 400 can vary depending on the time series data set being evaluated, in various embodiments, the design matrix 400 can be stored in a sparse representation so that the design matrix 400 can easily be stored and accessed in memory.

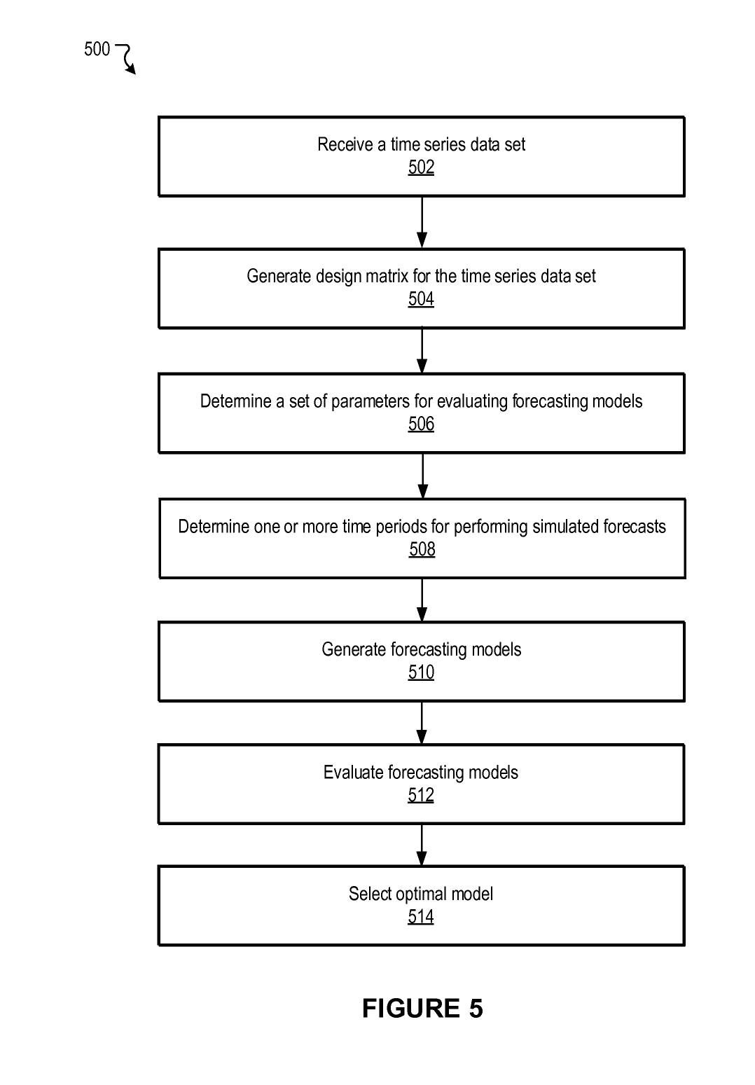

FIG. 5 illustrates an example method 500 that depicts generating a forecasting model for a time series, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive a time series data set. At block 504, the method 500 can generate a design matrix that can store various information about the time series data set. The method 500 can perform feature extraction techniques on the time series data set to extract various features and these features can be used to populate the design matrix. At block 506, the method 500 can determine a set of parameters to be used for evaluating forecasting models. For example, a user may specify a space of kernel parameters and a space of regularization parameters to be used in evaluating forecasting models. At block 508, the method 500 can determine one or more dates, or time periods, to be used for simulating forecasts. At block 510, the method 500 can generate forecasting models. The forecasting models can be generated, for example, based at least in part on the number of simulated dates, or time periods, and on the number of parameters being evaluated. At block 512, the method 500 can evaluate the generated forecasting models. The evaluation can include testing the forecasting accuracy of the model, as described above. At block 514, the method 500 can select an optimal model for the time series. Other suitable techniques are possible.

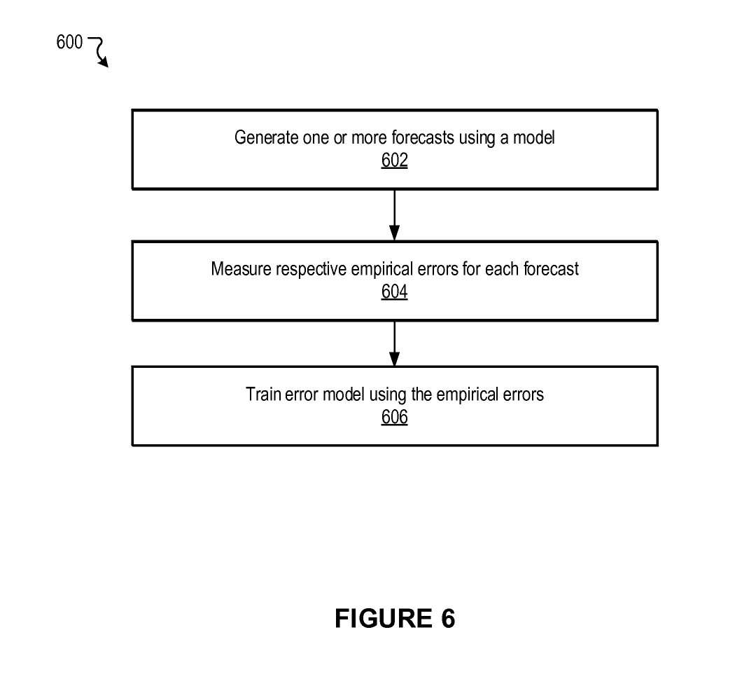

FIG. 6 illustrates an example method 600 for generating an error model, according to an embodiment of the present disclosure. It should be appreciated that there can be additional, fewer, or alternative steps performed in similar or alternative orders, or in parallel, within the scope of the various embodiments discussed herein unless otherwise stated.

At block 602, the example method 600 can generate one or more forecasts using a model. The forecasts can be made for a date, or time period, for which the actual value, or values, are known. At block 604, the method 600 can measure respective empirical errors that result from each of the forecasts made. At block 606, the method 600 can use the empirical errors to train an error model. The error model may be trained, for example, by applying various machine learning techniques, such as gradient boosting. The trained error model can be utilized to determine confidence intervals for forecasts made using a model. Other suitable techniques are possible.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content. As discussed previously, it should be appreciated that there can be many variations or other possibilities.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a model generator module 746. The model generator module 746 can, for example, be implemented as the model generator module 102 of FIG. 1. In some embodiments, the model generator module 746 may be implemented in a user device 710 or the external system 720. As discussed previously, it should be appreciated that there can be many variations or other possibilities.

### Hardware Implementation

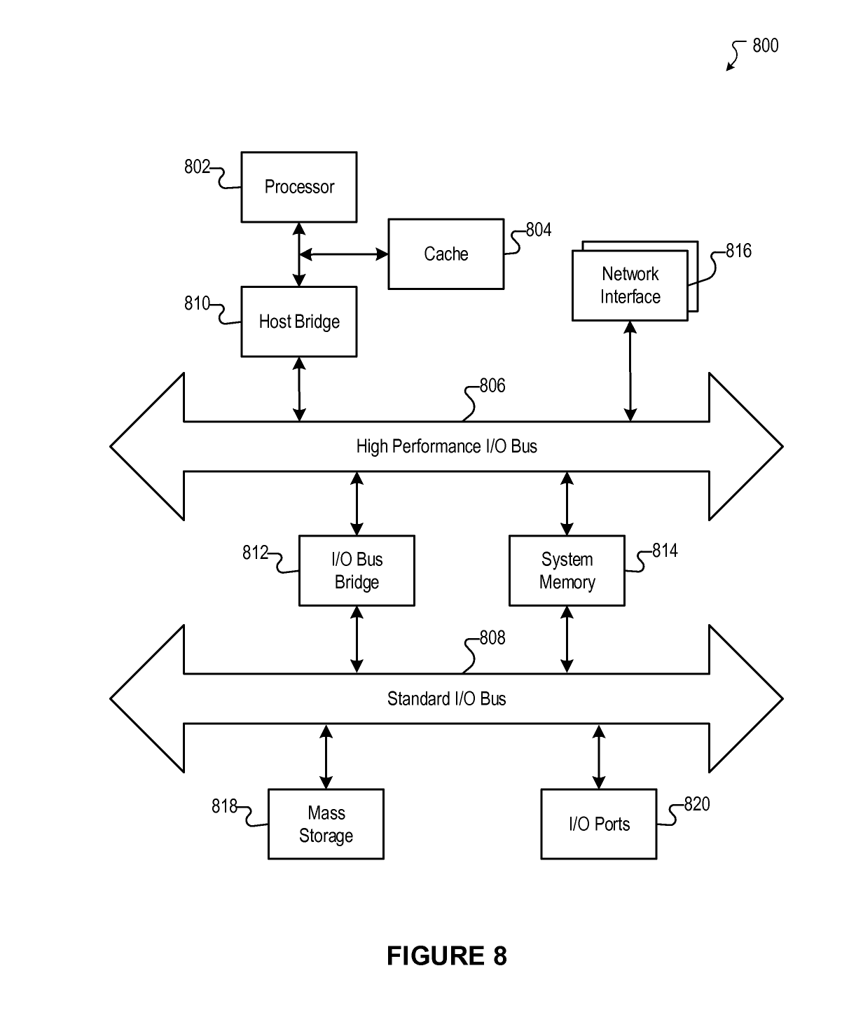

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a time series data set;
determining, by the computing system, at least one simulated forecast time period for the time series data set;
determining, by the computing system, one or more parameters for generating one or more forecasting models for the time series data set;
generating, by the computing system, the one or more forecasting models based at least in part on the one or more parameters and on the at least one simulated forecast time period; and
evaluating, by the computing system, the one or more forecasting models to determine an optimal forecasting model for the time series data set.

2. The computer-implemented method of claim 1, the method further comprising:
generating a design matrix for the time series data set, wherein the design matrix stores information describing at least a set of respective observations for each unit identified in the time series data set.

3. The computer-implemented method of claim 1, wherein determining, by the computing system, the at least one simulated forecast time period further comprises:
allocating a first portion of observations in the time series data set to a first set of observations, wherein observations in the first set are used to forecast simulated values; and
allocating a second portion of observations in the time series data set to a second set of observations, wherein observations in the second set are used to measure a respective accuracies of the simulated values.

4. The computer-implemented method of claim 1, wherein determining, by the computing system, the one or more parameters further comprises:
determining a space of kernel parameters; and
determining a space of regularization parameters.

5. The computer-implemented method of claim 1, wherein the one or more generated forecasting models each correspond to the at least one simulated forecast time period and each combination of the one or more parameters.

6. The computer-implemented method of claim 1, wherein evaluating, by the computing system, the one or more forecasting models further comprises:
determining at least one characteristic of the time series data set;
determining at least one different time series data set that corresponds to the at least one characteristic; and
determining a respective forecasting accuracy of each model in the one or more forecasting models with respect to the time series data set and the at least one different time series data set.

7. The computer-implemented method of claim 1, wherein evaluating, by the computing system, the one or more forecasting models further comprises:
determining a first portion of observations in the time series data set;
determining a second portion of observations in the time series data set, wherein observations included in the second portion are different from the observations included in the first portion;
generating at least one forecasted value based at least in part on the first portion of observations, wherein the forecasted value corresponds to an observation included in the second portion of observations; and
determining a forecasting accuracy for the model based at least in part on a comparison of the at least one forecasted value with a known value corresponding to the observation included in the second portion of observations.

8. The computer-implemented method of claim 1, wherein evaluating, by the computing system, the one or more forecasting models further comprises:
generating an error model based at least in part on the evaluation of the one or more forecasting models.

9. The computer-implemented method of claim 8, wherein generating the error model further comprises:
measuring respective empirical errors for one or more forecasted values made using at least one forecasting model; and
training the error model based at least in part on the one or more forecasted values and the respective empirical errors.

10. The computer-implemented method of claim 8, the method further comprising:
generating at least one forecasted value using a model in the one or more forecasting models; and
determining, using the error model, a confidence interval for the at least one forecasted value.

11. A system comprising:
at least one processor; and
a memory storing instructions that, when executed by the at least one processor, cause the system to perform:
receiving a time series data set;
determining at least one simulated forecast time period for the time series data set;
determining one or more parameters for generating one or more forecasting models for the time series data set;
generating the one or more forecasting models based at least in part on the one or more parameters and on the at least one simulated forecast time period; and
evaluating the one or more forecasting models to determine an optimal forecasting model for the time series data set.

12. The system of claim 11, wherein the instructions, when executed by the at least one processor, further cause the system to perform:
generating a design matrix for the time series data set, wherein the design matrix stores information describing at least a set of respective observations for each unit identified in the time series data set.

13. The system of claim 11, wherein determining the at least one simulated forecast time period further comprises:
allocating a first portion of observations in the time series data set to a first set of observations, wherein observations in the first set are used to forecast simulated values; and
allocating a second portion of observations in the time series data set to a second set of observations, wherein observations in the second set are used to measure a respective accuracies of the simulated values.

14. The system of claim 11, wherein determining the one or more parameters further comprises:
determining a space of kernel parameters; and
determining a space of regularization parameters.

15. The system of claim 11, wherein the one or more generated forecasting models each correspond to the at least one simulated forecast time period and each combination of the one or more parameters.

16. A non-transitory computer-readable storage medium including instructions that, when executed by at least one processor of a computing system, cause the computing system to perform a method comprising:
receiving a time series data set;
determining at least one simulated forecast time period for the time series data set;
determining one or more parameters for generating one or more forecasting models for the time series data set;
generating the one or more forecasting models based at least in part on the one or more parameters and on the at least one simulated forecast time period; and
evaluating the one or more forecasting models to determine an optimal forecasting model for the time series data set.

17. The non-transitory computer-readable storage medium of claim 16, wherein the instructions, when executed by the at least one processor, further cause the system to perform:
generating a design matrix for the time series data set, wherein the design matrix stores information describing at least a set of respective observations for each unit identified in the time series data set.

18. The non-transitory computer-readable storage medium of claim 16, wherein determining the at least one simulated forecast time period further comprises:
allocating a first portion of observations in the time series data set to a first set of observations, wherein observations in the first set are used to forecast simulated values; and
allocating a second portion of observations in the time series data set to a second set of observations, wherein observations in the second set are used to measure a respective accuracies of the simulated values.

19. The non-transitory computer-readable storage medium of claim 16, wherein determining the one or more parameters further comprises:
determining a space of kernel parameters; and
determining a space of regularization parameters.

20. The non-transitory computer-readable storage medium of claim 16, wherein the one or more generated forecasting models each correspond to the at least one simulated forecast time period and each combination of the one or more parameters.
